(19) United States
(12) Patent Application Publication
(10) Pub. No.: US 2024/0131953 A1
(43) Pub. Date: Apr. 25, 2024

(54) POWER SYSTEM

(71) Applicant: TOYOTA JIDOSHA KABUSHIKI KAISHA, Toyota-shi (JP)

(72) Inventor: Tohru NAKAMURA, Toyota-shi (JP)

(73) Assignee: TOYOTA JIDOSHA KABUSHIKI KAISHA, Toyota-shi (JP)

(21) Appl. No.: 18/460,265

(22) Filed: Aug. 31, 2023

(30) Foreign Application Priority Data
Oct. 19, 2022 (JP) 2022-168316

(51) Int. Cl. B60L 53/66; B60L 53/62; B60L 53/67; B60L 53/68

(52) U.S. Cl. CPC B60L 53/66; B60L 53/62; B60L 53/67; B60L 53/68

(57) ABSTRACT

A power system includes: a CEMS server; at least one power apparatus; and at least one vehicle. The power apparatus charges the vehicle in a first charging pattern, the vehicle transmits charging power values by the power apparatus to the CEMS server, and the server pairs an intended power apparatus having performed charging in the first charging pattern and an intended vehicle having transmitted a second charging pattern obtained based on the charging power values, if the first charging pattern and the second charging pattern match.

### CROSS REFERENCE TO RELATED APPLICATIONS

This nonprovisional application is based on Japanese Patent Application No. 2022-168316 filed on Oct. 20, 2022 with the Japan Patent Office, the entire content of which is hereby incorporated by reference.

### BACKGROUND

### Field

The present disclosure relates to a power system.

### Description of the Background Art

For example, Japanese Patent Laying-Open No. 2019-198156 discloses a charging system which includes a charging station, a vehicle, and a server. In the charging system, the charging station charges an electric power to the vehicle. In the charging system, the charging station also compares the value of a charging current transmitted from the vehicle to the server with the value of the charging current value supplied from the charging station for authentication of the vehicle.

### SUMMARY

In the above charging system, the percentage of charge of the battery is used for the authentication of the vehicle. Accordingly, the percentage of charge of a battery included in a vehicle that should not be authenticated and the percentage of charge of a battery included in a vehicle that should be authenticated may match by coincidence. In such a case, the vehicle that should not be authenticated may be successfully authenticated, resulting in low accuracy in authentication.

The present disclosure is made to solve the above problem, and an object of the present disclosure is to achieve improved accuracy in authentication of a chargeable or dischargeable vehicle.

A power system according to the present disclosure includes a server, at least one power apparatus, and at least one vehicle. The power apparatus charges the vehicle in a first charging pattern, the first charging pattern being a power pattern in which the power apparatus discharges an electric power and indicating charging power values from when the power apparatus starts charging the vehicle until a predetermined time period has passed. If the first charging pattern and a second charging pattern match, the second charging pattern being a power pattern in which the vehicle is charged and indicating charging power values from a start of charge of the vehicle by the power apparatus until the predetermined time period has passed, the server pairs an intended power apparatus having performed charging in the first charging pattern and an intended vehicle charged in the second charging pattern.

According to such a configuration, the intended power apparatus and the intended vehicle are paired if there is a match between the first charging pattern of the first power apparatus indicating the charging power values from the start of charge of the vehicle until the predetermined time period has passed and the second charging pattern of the vehicle indicating the charging power values from the start of charge of the vehicle until the predetermined time period has passed. Accordingly, the accuracy in authentication of vehicle improves, as compared to using a percentage of charge of the battery included in a vehicle at a particular point in time for the authentication of vehicle.

Moreover, the power apparatus transmits a first charging pattern unique to the power apparatus to the server. If the first charging pattern transmitted from the power apparatus and the second charging pattern transmitted from the vehicle match, the server pairs the power apparatus as the intended power apparatus and the vehicle as the intended vehicle.

According to such a configuration, the process such as the server generating the first charging pattern can be omitted.

Moreover, when the server starts charging by the power apparatus, the server generates and transmits to the power apparatus a first charging pattern that differs from a first charging pattern being used. The power apparatus charges the vehicle in the first charging pattern transmitted by the server. If the second charging pattern and the first charging pattern that the server has transmitted to the power apparatus match, the server pairs the intended power apparatus and the intended vehicle, and the server deletes the generated first charging pattern after pairing the intended power apparatus and the intended vehicle.

According to such a configuration, the server deletes the first charging pattern after pairing the intended power apparatus and the intended vehicle, and the number of first charging patterns can thereby be prevented from excessively increasing.

Moreover, the power system further includes a load which consumes an electric power. The server controls the intended power apparatus so that an amount of electric power charged by the intended power apparatus decreases with an increase in a requested amount of electric power from the load.

According to such a configuration, the load can be inhibited from running into power shortage.

Moreover, the server identifies a non-intended power apparatus which charges a vehicle in the first charging pattern that does not match the second charging pattern. The server controls the non-intended power apparatus so that a chargeable amount of electric power by the non-intended power apparatus is independent of the requested amount of electric power.

According to such a configuration, for example, the non-intended vehicle that transmits no second charging pattern can be charged by the non-intended vehicle.

Moreover, the server obtains a chargeable amount of electric power by the intended power apparatus, the intended vehicle or the intended power apparatus transmits the chargeable amount of electric power of the intended vehicle to the server, and the server determines a charged amount of electric power based on the chargeable amount of electric power of the intended power apparatus and the chargeable amount of electric power of the intended vehicle, transmits information indicating the charged amount of electric power to the intended power apparatus and the intended vehicle.

According to such a configuration, even if the intended vehicle and the intended power apparatus are unable to communicate with each other, the server can allow the intended power apparatus and the intended vehicle to recognize the charged amount of electric power that decreases with an increase of the requested amount of electric power from the load.

At least one power apparatus includes a plurality of power apparatuses. The at least one vehicle includes a plurality of vehicles. The plurality of power apparatuses charges vehicle in a plurality of first charging patterns, respectively, that are different from each other. The plurality of vehicles are charged in a plurality of second charging patterns, respectively, that are different from each other. In the plurality of first charging patterns and the respectively matching plurality of second charging patterns, the server pairs the intended power apparatus having performed charging in the first charging pattern and the intended vehicle charged in the second charging pattern.

According to such a configuration, the plurality of combinations of the plurality of intended vehicles and the plurality of intended power apparatuses can be paired.

A power system according to the present disclosure includes: a server; at least one power apparatus; and at least one vehicle. The vehicle discharges an electric power in a first discharging pattern to the power apparatus, the first discharging pattern being a power pattern in which the vehicle discharges an electric power and indicating discharging power values from when the vehicle starts discharging the electric power until a predetermined time period has passed. If the first discharging pattern and a second discharging pattern match, the second discharging pattern being a power pattern in which the power apparatus is supplied with an electric power and indicating discharging power values from when the vehicle starts discharging the electric power until the predetermined time period has passed, the server pairs an intended vehicle having discharged an electric power in the first discharging pattern and an intended power apparatus having been discharged an electric power to in the second discharging pattern.

According to such a configuration, the intended power apparatus and the intended vehicle are paired if there is a match between the first discharging pattern from the vehicle indicating discharging power values from when the vehicle starts discharging an electric power until the predetermined time period has passed and the second discharging pattern to the power apparatus indicating discharging power values from when the vehicle starts discharging an electric power until the predetermined time period has passed. Accordingly, the accuracy in authentication of vehicle improves, as compared to using a percentage of charge of the battery included in a vehicle at a particular point in time for the authentication of vehicle.

Moreover, the vehicle transmits a first discharging pattern unique to the vehicle to the server. If the first discharging pattern transmitted from the vehicle and the second discharging pattern transmitted from the power apparatus match, the server pairs the power apparatus as the intended power apparatus and the vehicle as the intended vehicle.

According to such a configuration, the process such as the server generating the first discharging pattern can be omitted.

Moreover, when the vehicle starts discharging an electric power, the server generates and transmits to the vehicle a first discharging pattern that differs from the first discharging pattern being used. The vehicle discharges an electric power to the power apparatus in the first discharging pattern transmitted by the server. If the second discharging pattern and the first discharging pattern that the server has transmitted to the vehicle matches, the server pairs the intended power apparatus and the intended vehicle, and the server deletes the generated first discharging pattern after pairing the intended power apparatus and the intended vehicle.

According to such a configuration, the server deletes the first discharging pattern after pairing the intended power apparatus and the intended vehicle, and the number of first discharging patterns can thereby be prevented from excessively increasing.

Moreover, the power system further includes a load which consumes an electric power. The server controls the intended vehicle so that a dischargeable amount of electric power by the intended vehicle increases with an increase in a requested amount of electric power from the load.

According to such a configuration, the load can be inhibited from running into power shortage. Moreover, the server identifies a non-intended vehicle which discharges an electric power in the first discharging pattern that does not match the second discharging pattern. The server controls the non-intended vehicle so that a dischargeable amount of electric power by the non-intended vehicle is independent of the requested amount of electric power.

According to such a configuration, for example, an electric power can be discharged even to a non-intended power apparatus that transmits no second discharging pattern.

Moreover, the server obtains a dischargeable amount of electric power to the intended power apparatus. The intended vehicle or the intended power apparatus transmits the dischargeable amount of electric power by the intended vehicle to the server. The server determines a discharged amount of electric power based on the dischargeable amount of electric power of the intended power apparatus and the dischargeable amount of electric power of the intended vehicle, and transmits information indicating the discharged amount of electric power to the intended power apparatus and the intended vehicle.

According to such a configuration, even if the intended vehicle and the intended power apparatus are unable to communicate with each other, the server can allow the intended power apparatus and the intended vehicle to recognize the discharged amount of electric power that increases with an increase of the requested amount of electric power from the load.

Moreover, at least one power apparatus includes a plurality of power apparatuses. At least one vehicle includes a plurality of vehicles. The plurality of vehicles discharge electric powers in a plurality of first discharging patterns, respectively, to the power apparatuses, the plurality of first discharging patterns being different from each other. The plurality of power apparatuses are supplied with electric powers in a plurality of second discharging patterns, respectively, that are different from each other. In the plurality of first discharging patterns and the respectively matching plurality of second discharging patterns, the server pairs the intended vehicle having discharged an electric power in the first discharging pattern and the intended power apparatus having received an electric power in the second discharging pattern.

According to such a configuration, a plurality of combinations of the plurality of intended vehicles and the plurality of intended power apparatus can be paired.

A server according to the present disclosure includes: at least one power apparatus; an interface for communications with at least one vehicle; and a processor. The power apparatus charges a vehicle in a first charging pattern, the first charging pattern being a power pattern in which a power apparatus discharges an electric power and indicating charging power values from when the power apparatus starts charging the vehicle until a predetermined time period has passed. If the first charging pattern and a second charging pattern match, the second charging pattern being a power pattern in which the vehicle is charged and indicating charging power values from a start of charge of the vehicle by the power apparatus until the predetermined time period has passed, the processor pairs the intended power apparatus having performed charging in the first charging pattern and the intended vehicle charged in the second charging pattern.

A server according to the present disclosure includes: at least one power apparatus; an interface for communications with at least one vehicle; and a processor. The vehicle discharges an electric power to a power apparatus in a first discharging pattern, the first discharging pattern being a power pattern in which the vehicle discharges an electric power and indicating discharging power values from when the vehicle starts discharging the electric power until a predetermined time period has passed. If the first discharging pattern and a second discharging pattern match, the second discharging pattern being a power pattern in which the power apparatus is supplied with an electric power and indicates discharging power values from when the vehicle starts discharging the electric power until the predetermined time period has passed, the processor pairs the intended vehicle having discharged an electric power in the first discharging pattern and the intended power apparatus having been discharged an electric power to in the second discharging pattern.

A method of control of electric power according to the present disclosure is a method of control of electric power between at least one power apparatus and at least one vehicle. The method includes: obtaining a first charging pattern, the first charging pattern being a power pattern in which a power apparatus discharges an electric power and indicates charging power values from when the power apparatus starts charging a vehicle until a predetermined time period has passed; and pairing an intended power apparatus having performed charging in the first charging pattern and an intended vehicle having been charged in a second charging pattern if the first charging pattern and the second charging pattern match, the second charging pattern being a power pattern in which the vehicle is charged and indicating charging power values from a start of charge of the vehicle by the power apparatus until the predetermined time period has passed.

A method of control of electric power according to the present disclosure is a method of control of electric power between at least one power apparatus and at least one vehicle. The method includes: obtaining a first discharging pattern, the first discharging pattern being a power pattern in which a vehicle discharges an electric power and indicating discharging power values from the vehicle starts discharging the electric power to a power apparatus until a predetermined time period has passed; and pairing an intended vehicle having discharged an electric power in the first discharging pattern and an intended power apparatus having been discharged an electric power to in a second discharging pattern if the first discharging pattern and the second discharging pattern match, the second discharging pattern being a power pattern in which the power apparatus is supplied with an electric power and indicating discharging power values from when the vehicle starts discharging the electric power until the predetermined time period has passed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a schematic configuration of a power system according to the present disclosure.

FIG. 2 is a diagram showing an example configuration of a power apparatus 17 and a vehicle 18, according to the present disclosure.

FIG. 3 is a functional block diagram of a CEMS server, etc., according to Embodiment 1.

FIG. 4 is a diagram showing one example of a comparison process performed by a processing unit.

FIG. 5 is a flowchart according to Embodiment 1.

FIG. 6 is a flowchart of a charging EM control.

FIG. 7 is a flowchart according to Embodiment 2.

FIG. 8 is a functional block diagram of a CEMS server, etc., according to Embodiment 3.

FIG. 9 is a flowchart according to Embodiment 3.

FIG. 10 is a flowchart of a discharging EM control process.

FIG. 11 is a flowchart according to Embodiment 4.

### DESCRIPTION OF THE PREFERRED EMBODIMENTS

Hereinafter, embodiments of the present disclosure will be described, with reference to the accompanying drawings. Note that like reference signs are used to refer to like or corresponding parts in the drawings, and the description thereof will not be repeated.

### Embodiment 1

[Overall Configuration of Management System]

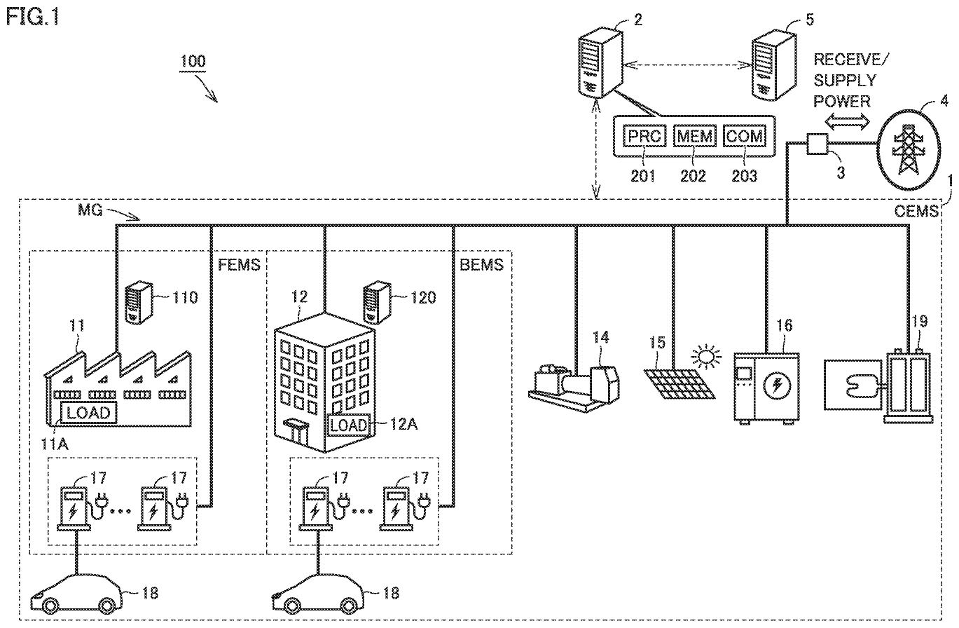

FIG. 1 is a diagram showing a schematic configuration of a power system, according to Embodiment 1 of the present disclosure. The power system 100 includes a CEMS 1, a CEMS server 2, a power reception and transformation facility 3, a power system 4, and an electricity transmission and distribution provider server 5. The CEMS refers to a community energy management system or a city energy management system.

The CEMS 1 includes a factory energy management system (FEMS), a building energy management system (BEMS), a generator 14, a variable renewable energy 15, an energy storage system (ESS) 16, a power apparatus 17, at least one vehicle 18, and a thermal storage system 19, which form a microgrid MG in the CEMS 1. Note that the microgrid MG corresponds to one example of a “power grid” according to the present disclosure. The FEMS and the BEMS may collectively be referred to as a “xEMS.” The CEMS 1 may also include a home energy management system (HEMS). The at least one vehicle 18 is, typically, multiple vehicles 18.

The FEMS is a system that manages the supply and demand of electric power used in the factory 11. The FEMS includes a factory 11, at least one power apparatus 17, and a FEMS server 110 that is capable of two-way communications with the CEMS server 2. The at least one power apparatus 17 is, typically, multiple power apparatuses 17. The factory 11 has a load 11A. The load 11A operates with an electric power supplied from the microgrid MG. The load 11A includes, for example, an air-conditioning facility, a lighting device, and industrial facilities (a production line), etc. Although not shown, the FEMS can include power generating equipment (such as a generator, and a photovoltaic panel). An electric power generated by these power generating equipment may be supplied to the microgrid MG. The FEMS may also include a cold source system (such as a waste heat recovery system and a thermal storage system).

The power apparatus 17 is configured to charge the vehicle 18. The power apparatus 17 may be a home charger. The power apparatus 17 may be configured to be electrically connected to the microgrid MG and discharge (supply) electric power to the microgrid MG.

The vehicle 18 is, specifically, a plug-in hybrid vehicle (PHV) or an electric vehicle (EV), etc. The vehicle 18 is configured to receive an electric power from the microgrid MG by an inlet (not shown) of the vehicle 18 being connected to a charging cable extending from the power apparatus 17 (external charging). The vehicle 18 may also be configured to discharge an electric power to the power apparatus 17 by the charging cable being connected to an outlet (not shown) of the vehicle 18 (external charging).

The BEMS is a system that manages the supply and demand of electric power used in buildings such as offices and commercial facilities. The BEMS includes a building 12, at least one power apparatus 17, a BEMS server 120 that is capable of two-way communications with the CEMS server 2. The building 12 has a load 12A. The load 12A operates with an electric power supplied from the microgrid MG. The load 12A includes an air-conditioning facility and a lighting device that are installed in the building 12, for example. The BEMS may include power generating equipment and/or a cold source system. In the present embodiment, the factory 11 and the building 12 may collectively be referred to as a “facility.” The at least one power apparatus 17 is managed by the facility.

The generator 14 is a power generation facility independent of meteorological conditions. The generator 14 outputs generated power to the microgrid MG. The generator 14 can include a steam turbine generator, a gas turbine generator, a diesel engine generator, a gas engine generator, a biomass power generator, a stationary fuel cell, etc. The generator 14 may include a cogeneration system that utilizes heat that is produced upon electric power generation.

The variable renewable energy source 15 is a power generation facility whose power output varies depending on meteorological conditions. The variable renewable energy source 15 outputs generated power to the microgrid MG. While FIG. 1 illustrates the solar power generation equipment (a photovoltaic panel), the variable renewable energy source 15 may include wind power generation equipment, instead of or in addition to the solar power generation equipment.

The energy storage system 16 is a stationary power storage device that stores power generated by the variable renewable energy 15, for example. The power storage device is a secondary battery such as a lithium-ion battery or a nickel-hydrogen battery, which can be, for example, a traction battery (recycled) that was used to be mounted on a vehicle. However, the energy storage system 16 is not limited to a secondary battery, and may be a power-to-gas device that produces a gaseous fuel (such as hydrogen, methane) using surplus power.

In the present embodiment, in the example of FIG. 1, the factory in the FEMS possesses at least one power apparatus 17, and the building in the BEMS possesses at least one power apparatus 17.

The thermal storage system 19 includes a thermal storage vessel provided between a heat source and a load (such as an air-conditioning facility), and is configured to temporarily store a liquid medium within the thermal storage vessel in a warmed state. The use of the thermal storage system 19 allows temporary staggering of the generation and consumption of heat. For example, it is possible that the heat that is generated by operating the heat source by consuming the power is stored into the thermal storage vessel during a night, and that heat is consumed to condition the air during the daytime.

While in the example shown in FIG. 1, the CEMS 1 includes one FEMS, one BEMS, one generator 14, one variable renewable energy 15, one energy storage system 16, one power apparatus 17, one vehicle 18, and one thermal storage system 19, the CEMS 1 may include any number of these systems or equipment. The CEMS 1 may include multiple number of these systems or equipment or some of the systems or equipment may not be included in the CEMS 1. The FEMS or the BEMS may include equipment such as the generator, or the power apparatus and the vehicle. These systems or equipment may each be referred to as a “power adjustment resource” according to the present disclosure.

The CEMS server 2 is a computer that manages the power adjustment resources within the CEMS 1. The CEMS server 2 includes a control device 201, a storage device 202, and a communication device 203. The control device 201 includes a processor and is configured to perform predetermined arithmetic processes. The processor is also referred to as a “control circuit.” The storage device 202 includes a memory storing programs that are executed by the control device 201, and also storing various information (maps, relational expressions, parameters, etc.) that are used in the programs. The storage device 202 also includes a database, storing data related to the powers of the systems or equipment included in the CEMS 1 (such as power generation history, power consumption history). The communication device 203 includes a communications interface and is configured to perform communications externally (with other servers, etc.).

Moreover, a vehicle identification (ID) is assigned to each vehicle 18 included in the power system 100. The vehicle ID is information identifying the vehicle 18. The CEMS server 2 also holds a vehicle data base (DB) in which all the vehicle IDs are defined. In the vehicle DB, an address of each vehicle 18 indicated by the vehicle ID thereof is defined for the vehicle ID. In this manner, the CEMS server 2 is able to identify all the vehicle IDs and the all the vehicle addresses.

A power apparatus ID is assigned to each power apparatus 17 included in the power system 100. The power apparatus ID is information identifying the power apparatus 17. The CEMS server 2 also holds a power apparatus DB in which all the power apparatus IDs are defined. In the power apparatus DB, an address of each power apparatus 17 indicated by the power apparatus ID thereof is defined for the power apparatus ID. In this manner, the CEMS server 2 is able to identify all the power apparatus IDs and all the power apparatus addresses.

The CEMS server 2 may be an aggregator server. The aggregator is an electric utility that aggregates multiple power adjustment resources and provides energy management services. The CEMS server 2 corresponds to one example of a “server” according to the present disclosure. The servers (110, 120) included in each of the FEMS and the BEMS may also be the “server” according to the present disclosure.

The power reception and transformation facility 3 is provided at a power reception point (a point of interconnection) of the microgrid MG, and capable of connection/disconnection switching between the microgrid MG and the power system 4. The power reception and transformation facility 3 includes a switch on a high voltage side (a primary side), a transformer, a protective relay, a measurement instrument, and a controller (none of which are shown). When the microgrid MG is interconnected with the power system 4, the power reception and transformation facility 3 receives, for example, an alternating-current (AC) power having an extra-high voltage (a voltage above 7000V) from the power system 4, steps down the received power, and supplies a resultant power to the microgrid MG.

The power system 4 is a power grid built of a power plant and power transmission and distribution equipment. In the present embodiment, a power company serves as a power generation utility and an electricity transmission and distribution provider. The power company corresponds to a general electricity transmission and distribution provider and an administrator of the power system 4, and maintains and manages the power system 4.

The electricity transmission and distribution provider server 5 is a computer that belongs to the power company and manages the demand and supply of electric power of the power system 4. The electricity transmission and distribution provider server 5 is also capable of two-way communications with the CEMS server 2.

[Configuration of Vehicle and Power Apparatus]

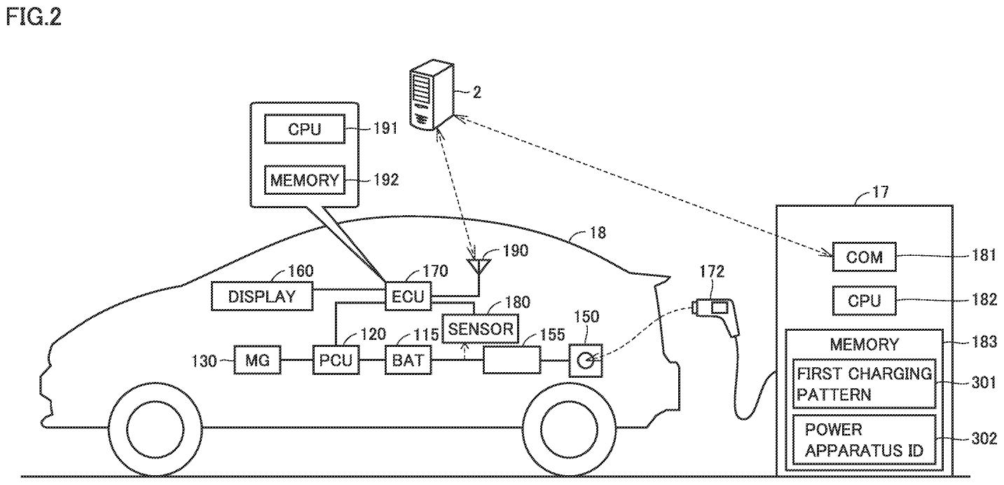

FIG. 2 is a diagram for illustrating an example configuration of the power apparatus 17 and the vehicle 18, according to the present embodiment. In the example of FIG. 2, the power apparatus 17 has a communication device 181, a central processing unit (CPU) 182, a memory 183, and a connector 172. The connector 172 is inserted into the inlet 150 of the vehicle 18 by a user. The power apparatus 17 charges the vehicle 18 with the connector 172 being inserted in the inlet 150 (hereinafter, also referred to as an “inserted state”).

The memory 183 stores charging patterns and power apparatus IDs described below. In the present embodiment, a pattern of charging performed by the power apparatus 17 is also referred to as a “first charging pattern”. A first charging pattern 301 is a power pattern in which the power apparatus 17 discharges an electric power to the vehicle 18. The first charging pattern 301 is unique to the power apparatus 17 that has the memory 183 storing the first charging pattern 301. In other words, the power apparatuses 17 included in the power system 100 have first charging patterns 301 that are all different from each other.

The CPU 182 performs various processes. For example, the CPU 182 charges the vehicle 18 through the connector 172, in accordance with the first charging pattern 301. The communication device 181 is capable of communications with the CEMS server 2.

The vehicle 18 includes the inlet 150, a charger 155, a sensor 180, a battery 115, a power control unit (PCU) 120, an electronic control unit (ECU) 170, a motor generator 130, a display 160, and a communication module 190.

The ECU 170 is configured of a CPU 191 and a memory 192. The memory 192 stores various information. For example, the memory 192 stores vehicle identification information (hereinafter, a vehicle identification (ID)) of the vehicle 18 that includes the memory 192.

In the inserted state in which the connector 172 is being inserted in the inlet 150, the vehicle 18 is configured to receive an electric power from the microgrid MG via the power apparatus 17 (external charging). In the inserted state, the vehicle 18 may be configured to discharge an electric power to the power apparatus 17 via the power apparatus 17 (supply an electric power to the microgrid MG) (external charging).

The charger 155 converts an electric power supplied from the inlet 150 into one that the battery 115 can be charged with. The battery 115 is a power storage element capable of charging and discharging of electric power. The battery 115 includes, for example, a secondary battery such as a lithium-ion battery or a nickel-hydrogen battery, or a power storage element such as an electric double layer capacitor. The battery 115 stores an electric power for generating a travel driving force by the motor generator 130. The battery 115 supplies the stored electric power to the PCU 120.

The PCU 120 is a drive for driving the motor generator 130, and includes power conversion devices such as a converter and an inverter (none of which are shown). The PCU 120 is controlled by the ECU 170, and converts direct-current (DC) power, received from the battery 115, into an AC power for driving the motor generator 130.

The PCU 120 rectifies the electric power, which is generated by the motor generator 130 upon breaking of the vehicle 18, into a voltage level for the battery 115, and outputs the rectified electric power to the battery 115. The battery 115 is capable of storing the generated power. The generated power is externally discharged to the microgrid MG. The display 160 displays various information under control by the ECU 170.

While the vehicle 18 is being charged by the power apparatus 17, the sensor 180 detects a charging power value every predetermined time period (e.g., 0.1 seconds). Each time the sensor 180 detects a charging power value, the sensor 180 outputs the charging power value to the ECU 170. Furthermore, each time the ECU 170 obtains a charging power value from the sensor 180, the ECU 170 transmits the charging power value to the CEMS server 2.

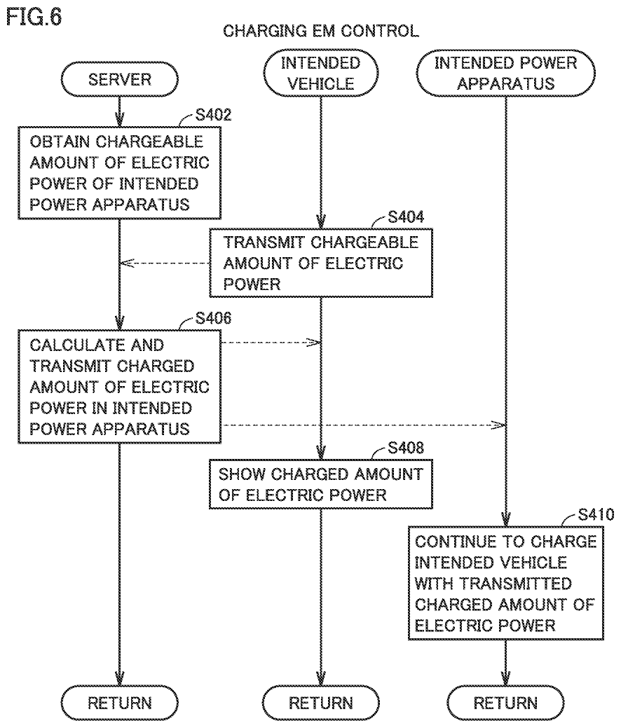

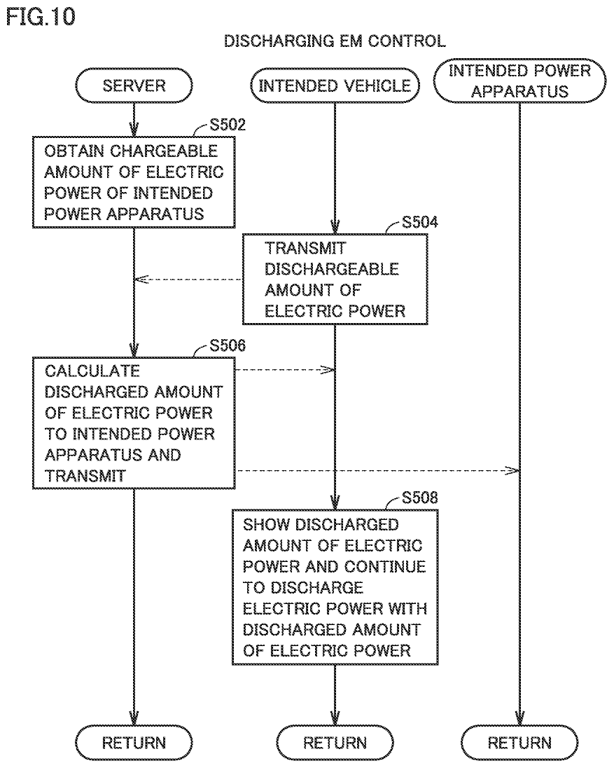

In the above-mentioned inserted state, the vehicle 18 and the power apparatus 17 are connected together not only through a power line, but also through a communication line. Using the communication line, the vehicle 18 and the power apparatus 17 are capable of exchanging predetermined data only in a wired manner. The predetermined data is used for both energy management control (hereinafter, also referred to as an “EM control”) and typical control described below. The predetermined data, for example, relates to charging between the vehicle 18 and the power apparatus 17. The predetermined data is, for example, about the remaining amount of the battery 115. In contrast, particular data, which is not used in the typical control but used only in the EM control, is not exchanged using the communication line, between the vehicle 18 and the power apparatus 17. The particular data is, for example, a chargeable amount of electric power and a charged amount of electric power described below (see FIG. 6), and a dischargeable amount of electric power and a discharged amount of electric power described below (see FIG. 10). With such a configuration, the configuration of the wired communications between the vehicle 18 and the power apparatus 17 can be simplified.

[CEMS Server]

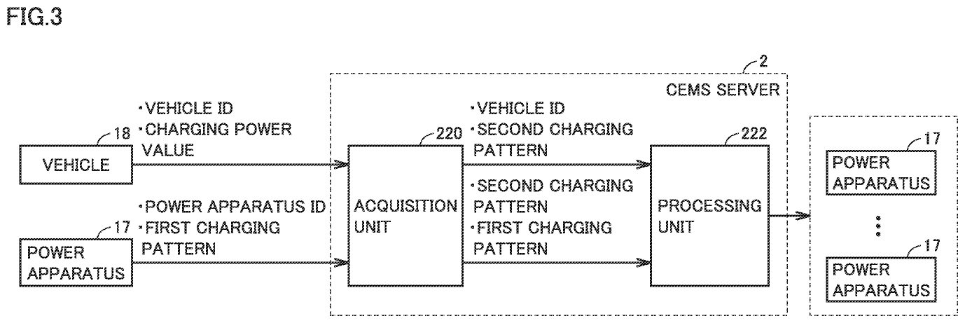

Next, processing performed by the CEMS server 2 is described. FIG. 3 is a functional block diagram of the CEMS server 2, etc. In the example of FIG. 3, the CEMS server 2 has an acquisition unit 220 and a processing unit 222.

Once the power apparatus 17 starts charging the vehicle 18, each time a charging power value is detected by the sensor 180 (see FIG. 2), the vehicle 18 outputs the charging power value to the CEMS server 2. Once the power apparatus 17 starts charging the vehicle 18, the vehicle 18 also transmits to the CEMS server 2 the vehicle ID stored in the memory 192 (see FIG. 2) of the vehicle 18.

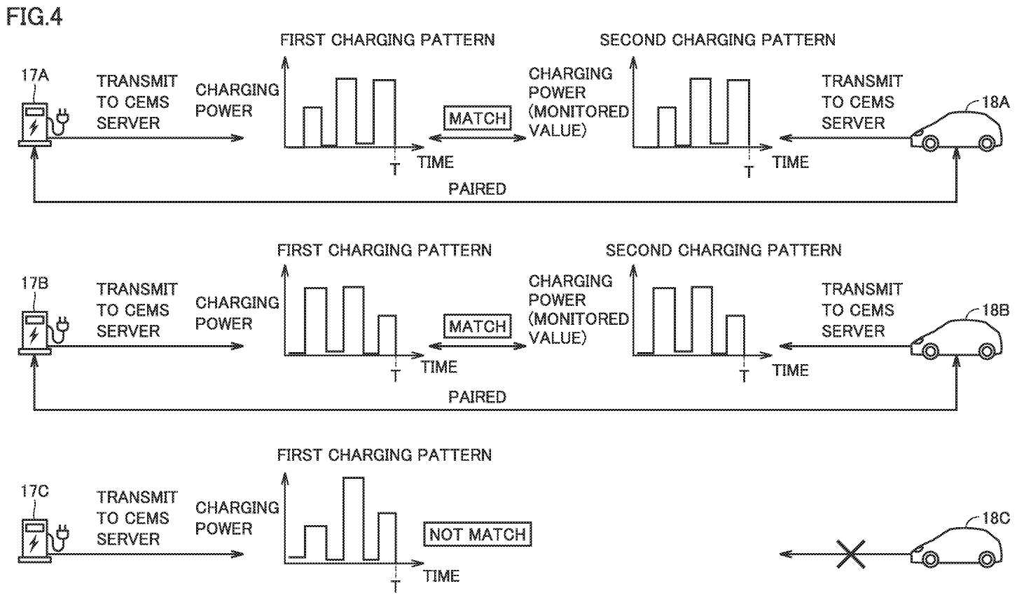

The acquisition unit 220 included in the CEMS server 2 obtains the vehicle ID and the charging power value from the vehicle 18. In turn, the acquisition unit 220 continues to obtain charging power values from when it starts obtaining charging power values until a predetermined time period T (e.g., 10 seconds) of FIG. 4, described below, has passed. The acquisition unit 220 continues to obtain charging power values over the predetermined time period T, and obtains a charging pattern (a second charging pattern) based on the obtained charging power values. The second charging pattern is a power pattern in which the vehicle 18 is charged. The second charging pattern and the vehicle ID, obtained by the acquisition unit 220, are output to the processing unit 222.

Moreover, when the power apparatus 17 starts charging the vehicle 18, the power apparatus 17 transmits the first charging pattern of the power apparatus 17 and the power apparatus ID of the power apparatus 17 to the server. The acquisition unit 220 obtains and outputs the first charging pattern and the power apparatus ID to the processing unit 222.

The processing unit 222 compares the first charging pattern and the second charging pattern output from the acquisition unit 220, and determines whether the first charging pattern and the second charging pattern match. The “match,” as used herein, encompasses not only “complete match,” but also “approximate match.” If the processing unit 222 determines that the first charging pattern and the second charging pattern match, the processing unit 222 identifies that the power apparatus 17, having performed charging in the first charging pattern, has charged the vehicle 18 in the second charging pattern, which is also referred to as “the power apparatus 17 and the vehicle 18 being paired.” The power apparatus 17 is also referred to as an “intended power apparatus.” The vehicle 18 is also referred to as an “intended vehicle.” Pairing of the intended power apparatus and the intended vehicle means, for example, storing, in the storage device 202 (e.g., Random Access Memory (RAM)) of the CEMS server 2, the power apparatus ID of the intended power apparatus and the vehicle ID of the intended vehicle in association with each other.

In other words, if the first charging pattern and the second charging pattern match, the processing unit 222 identifies the intended power apparatus and the intended vehicle. “The case where the first charging pattern and the second charging pattern do not match” will be described below with respect to FIG. 4. Upon identifying the intended power apparatus and the intended vehicle, the processing unit 222 causes the intended power apparatus and the intended vehicle to perform the EM control described below.

FIG. 4 is a diagram for illustrating one example of a comparison process performed by the processing unit 222. FIG. 4 shows the first charging pattern from the power apparatus 17A and the second charging pattern from the vehicle 18A. As shown in FIG. 4, the first charging pattern is information indicating charging power values by the power apparatus 17 from when the power apparatus 17 starts charging the vehicle 18 until the predetermined time period T has passed. The second charging pattern is information indicating charging power values of the vehicle 18 from the start of charge of the vehicle 18 until the predetermined time period T has passed.

Next, the comparison process between the first charging pattern and the second charging pattern is described. For example, the processing unit 222 divides each of the first charging pattern and the second charging pattern every particular time (e.g., 1 seconds), and compares multiple first charging patterns obtained from the division and multiple second charging patterns obtained from the division, respectively. As a result of the comparison, if the first charging pattern and the second charging pattern match, the processing unit 222 identifies the power apparatus in the first charging pattern as an intended power apparatus and the vehicle in the second charging pattern as an intended vehicle. The processing unit 222 may perform the comparison process in other approach.

FIG. 4 shows the power apparatus 17A and the vehicle 18A being paired, and the power apparatus 17B and the vehicle 18B being paired. FIG. 4 also shows that the power apparatus 17C charges the vehicle 18C and transmits the first charging pattern to the CEMS server 2, but the vehicle 18C does not transmit a second charging pattern. The vehicle 18C has no function for transmitting a second charging pattern. The vehicle 18C is a “guest vehicle” whose vehicle ID is not registered to the CEMS server. The vehicle 18C may also be one that has a function for transmitting a second charging pattern but the function is at fault and the vehicle 18C is thus unable to transmit a second charging pattern. The power apparatus 17C not paired with a vehicle as such is also referred to as a “non-intended power apparatus.”

For the comparison process illustrated in FIG. 4, during a waiting period (e.g., seconds) since the processing unit 222 obtains a first charging pattern, the processing unit 222 waits until it can obtain a second charging pattern having the same pattern as the first charging pattern. If the processing unit 222 obtains a second charging pattern having the same pattern as the first charging pattern during the particular period, the processing unit 222 identifies that the power apparatus 17 in the first charging pattern and the vehicle 18 in the second charging pattern have been paired. If the processing unit 222 fails to obtain a second charging pattern having the same pattern as the first charging pattern during the waiting period, the processing unit 222 identifies the power apparatus 17 in the first charging pattern as a “non-intended power apparatus.”

For example, in a conventional power system, a charging station compares the percentage of charge transmitted from a vehicle to a server and the percentage of charge obtained by the charging station for authentication of the vehicle. However, in such as conventional charging system, a percentage of charge at a particular point in time is used for the authentication of a vehicle. Accordingly, the percentage of charge of a vehicle that should not be authenticated and the percentage of charge of a vehicle that is connected to the charging station may match by coincidence. In such as case, the vehicle that should not be authenticate may be authenticated, resulting in low accuracy in authentication.

In the power system 100 according to the present embodiment, in contrast, the vehicle 18 is authenticated, based on the first charging pattern and the second charging pattern. The first charging pattern and the second charging pattern are patterns each showing a time series of charging power values from the start of charge of the vehicle 18 until the predetermined time period T (see FIG. 4) has passed. In other words, each of the first charging pattern and the second charging pattern is information that has a temporal width in charging power value. Accordingly, it is highly unlikely that the charging pattern of the vehicle 18 that should not be authenticates and the charging pattern of an electric power that is supplied from the power apparatus 17 match by coincidence. Accordingly, the accuracy of authentication of the vehicle 18 is improved, as compared to using the percentage of charge of the battery for authentication of a vehicle.

A configuration is contemplated, in which the vehicle 18 is authenticated through wireless communications with the power apparatus 17 charging the vehicle 18. However, with such a configuration, if multiple vehicles 18 are charged at a location that is dense with power apparatuses, the wireless communications may be subjected to a crosstalk. In such a case, a false vehicle may be authenticated. In the present embodiment, in contrast, the CEMS server 2 authenticates a vehicle. Accordingly, a vehicle can be authenticated properly even at a location that is dense with power apparatuses 17, without causing such a crosstalk to occur.

The example of FIG. 4 also shows multiple first charging patterns of multiple power apparatuses (the intended power apparatus 17A and the intended power apparatus 17B in the example of FIG. 4), and respectively matching multiple second charging patterns (the intended vehicle 18A and the intended vehicle 18B)). The CEMS server 2 pairs the intended power apparatus having performed charging in the first charging pattern with the intended vehicle charged in the second charging pattern. In other words, in the example of FIG. 4, the CEMS server 2 is able to pair the intended power apparatus 17A with the intended vehicle 18A, and pair the intended power apparatus 17B with the intended vehicle 18B (i.e., multiple paired sets).

[Process Flow]

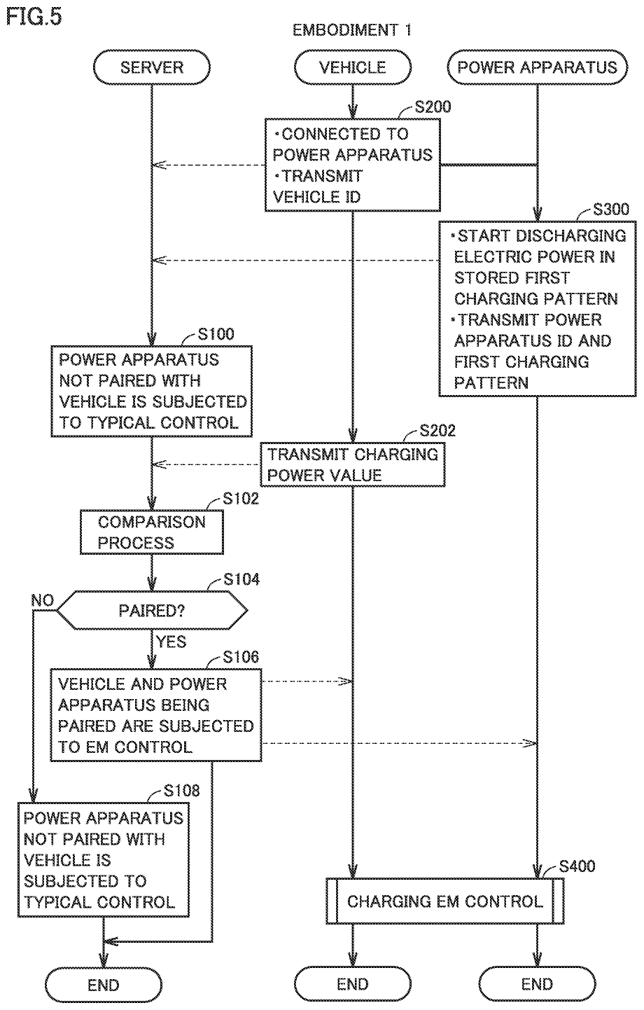

FIG. 5 is a flowchart of a process performed by the CEMS server 2, the vehicle 18, and the power apparatus 17. In step S200, as the vehicle 18 senses that it is connected to the power apparatus 17, the vehicle 18 transmits to the CEMS server 2 the vehicle ID of the vehicle 18 and a sensed signal indicating that the vehicle 18 has sensed that it is connected to the power apparatus 17. In step S300, the power apparatus 17 connected to the vehicle 18 starts charging the vehicle 18 in the first charging pattern 301 (see FIG. 2) stored in the power apparatus 17. In step S300, the power apparatus 17 also transmits the power apparatus ID of the power apparatus 17 and the first charging pattern of the power apparatus 17 to the CEMS server 2.

In step S100, the CEMS server 2 receives the sensed signal transmitted in step S200 and the first charging pattern transmitted in step S300. In step S100, the CEMS server 2 senses, by this reception, that the power apparatus 17 indicated by the power apparatus ID transmitted in step S300 has started charging the vehicle 18 indicated by the vehicle ID transmitted in step S200.

In step S202, each time the sensor 180 (see FIG. 2) detects a charging power value, the vehicle 18 transmits the charging power value to the CEMS server 2.

Next, in step S102, the CEMS server 2 performs the comparison process (see FIG. 4) to determine whether the vehicle 18 and the power apparatus 17 are paired. If they are paired (YES in step S104), the CEMS server 2, in step S106, causes the intended vehicle and the intended power apparatus being paired together to perform the charging EM control. Specifically, the CEMS server 2 transmits an EM-control signal to the intended vehicle and the intended power apparatus. Upon receiving the EM-control signal, the intended vehicle and the intended power apparatus recognize that they are to perform the charging EM control. In step S400, the intended vehicle and the intended power apparatus perform the charging EM control.

If they are not paired (NO in step S104), in contrast, the CEMS server 2, in step S108, causes the power apparatus (a non-intended power apparatus), not paired with a vehicle, to perform the typical control described below. Specifically, the CEMS server 2 transmits a typical-control signal to the non-intended power apparatus.

FIG. 6 is a flowchart illustrating one example of the charging EM control process. Note that the charging EM control and a discharging EM control described below are performed by the intended vehicle and the intended power apparatus that are paired together. Accordingly, the charging EM control and the discharging EM control described below are performed based on an address corresponding to the vehicle ID of the intended vehicle stored in the vehicle DB mentioned above, and an address corresponding to the power apparatus ID of the intended power apparatus stored in the power apparatus DB.

Initially, in step S402, the CEMS server 2 obtains a chargeable amount of electric power of the intended power apparatus from a server of the xEMS to which the intended power apparatus belongs. Here, the “chargeable amount of electric power” refers to an amount of electric power that the intended power apparatus can charge to the intended vehicle (an amount of electric power the charging of which is permitted). The chargeable amount of electric power is calculated by a server (hereinafter, also referred to as an “intended server”) of the xEMS to which the intended power apparatus belongs. For example, if the intended power apparatus belongs to the FEMS, the intended server is the FEMS server 110 (see FIG. 1). If the intended power apparatus belongs to the BEMS, the intended server is the BEMS server 120 (see FIG. 1).

The intended server also calculates the chargeable amount of electric power based on a predetermined algorithm, using a total amount of electric power supplied from the MG (a power grid) to the xEMS to which the intended server belongs, and a requested amount of electric power from the load 11A, 12A (see FIG. 1) of the facility (such as the factory 11 or the building 12 of FIG. 1) of the xEMS. The algorithm is defined so that the chargeable amount of electric power by the intended power apparatus decreases with an increase in the requested amount of electric power from the load 11A, 12A. This can reduce the chargeable amount of electric power by the intended power apparatus even if the requested amount of electric power from the load 11A, 12A is great, thereby inhibiting the load 11A, 12A from running into power shortage. The algorithm may also be defined so that the chargeable amount of electric power by the intended power apparatus increases with a reduction in the requested amount of electric power from the load 11A, 12A. This allows a larger amount of electric power to be supplied to the vehicle 18 for a smaller requested amount of electric power from the load 11A, 12A.

In step S404, the intended vehicle calculates and transmits a chargeable amount of electric power to the CEMS server 2. The ECU 170 (see FIG. 2) included in the intended vehicle calculates the chargeable amount of electric power, based on a predetermined arithmetic operation. For example, the predetermined arithmetic operation is subtraction of the current capacity of the battery 115 from the full charge capacity of the battery 115. Note that, in an alternative embodiment, the intended vehicle may transmit a chargeable amount of electric power to the intended power apparatus, and the intended power apparatus, in turn, may transmit the chargeable amount of electric power to the CEMS server 2.

The intended vehicle transmits the chargeable amount of electric power to the CEMS server 2. In step S406, the CEMS server 2 identifies a charged amount of electric power in the intended power apparatus, based on the chargeable amount of electric power obtained in step S402 and the chargeable amount of electric power transmitted from the intended vehicle in step S404. For example, in step S406, the CEMS server 2 identifies a smaller chargeable amount of electric power of the chargeable amount of electric power obtained in step S402 and the chargeable amount of electric power transmitted from the intended vehicle in step S404, as the charged amount of electric power by the intended power apparatus. The CEMS server 2 then transmits information indicating the identified charged amount of electric power to the intended vehicle and the intended power apparatus.

In step S408, the ECU 170 included in the intended vehicle shows the charged amount of electric power transmitted in step S406 on the display 160 (see FIG. 2). This display can allow passengers of the intended vehicle to recognize the charged amount of electric power.

In step S410, the intended power apparatus continues to charge the intended vehicle with the charged amount of electric power transmitted in step S406. “Continue to charge” means that the intended power apparatus switches from the first charging pattern in step S300 to a typical pattern and continues to charge the intended vehicle until the completion of charging of the intended vehicle with the charged amount of electric power transmitted in step S406.

As such, in the charging EM control, even if the charged amount of electric power determined by the charging EM control cannot be communicated between the intended vehicle and the intended power apparatus, the CEMS server 2 can transmit the charged amount of electric power to the intended power apparatus and the intended vehicle. Accordingly, the CEMS server 2 can allow the intended power apparatus and the intended vehicle to recognize the charged amount of electric power.

As the charging EM control of FIG. 6 ends, the process returns to FIG. 5 and the process of FIG. 5 ends. Moreover, the CEMS server 2 causes that non-intended power apparatus (e.g., the power apparatus 17C of FIG. 4), having been determined as NO in step S104 of FIG. 5, to perform the typical control. The typical control differs from the charging EM control. In other words, in the typical control, the chargeable amount of electric power by the non-intended power apparatus is independent of a requested amount of electric power from a load. For example, the typical control allows a vehicle (e.g., a guest vehicle 18C of FIG. 4), connected to a non-intended power apparatus, to be charged with the same charge amount of electric power as the chargeable amount of electric power calculated by the vehicle. In this manner, even if a guest vehicle 18C (see FIG. 4) is charged by the power apparatus 17C while they are not paired, the non-intended vehicle can be charged appropriately.

### Embodiment 2

In Embodiment 1 described above, the power apparatus 17 stores the first charging pattern 301 unique to the power apparatus 17 (see FIG. 2). In Embodiment 2, a CEMS server 2 generates a first charging pattern unique to a power apparatus 17 and transmits the first charging pattern to the power apparatus 17. The power apparatus 17, in turn, charges a vehicle 18 in the first charging pattern.

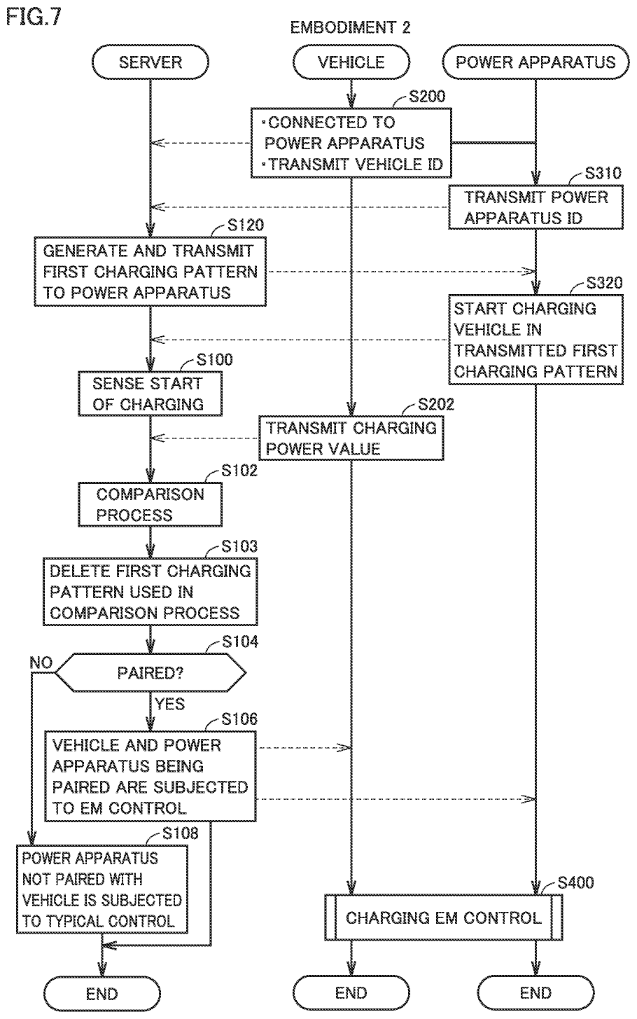

FIG. 7 is a flowchart of a process performed by the CEMS server 2, the vehicle 18, and the power apparatus 17, according to Embodiment 2. The power apparatus 17, having sensed that it is connected to the vehicle 18, transmits a power apparatus ID of the power apparatus 17 to the CEMS server 2 in step S310.

Upon receiving the power apparatus ID, the CEMS server 2, in step S120, generates a first charging pattern. Here, the first charging pattern differs from a first charging pattern being used. The “first charging pattern being used” refers to a first charging pattern that is present since being generated in step S120 until being deleted in step S103 described below. Accordingly, during a time period from when the power apparatus 17 starts charging a vehicle until the end of the comparison process of step S102, the first charging pattern generated in step S120 differs from any other first charging patterns for any other power apparatuses.

In step S120, the CEMS server 2 stores the generated first charging pattern data into a memory (e.g., a RAM) included in the CEMS server 2, and transmits the first charging pattern to the power apparatus 17 which is a source of the power apparatus ID.

Upon receiving the first charging pattern from the CEMS server 2, the power apparatus 17, in step S320, starts charging the vehicle 18 in the first charging pattern. The power apparatus 17 transmits to the CEMS server 2 a start signal indicating that the charging has started. In step S100, the CEMS server 2 senses, by receiving the start signal, that the power apparatus 17 indicated by the power apparatus ID transmitted in step S310 has started charging the vehicle 18 indicated by the vehicle ID transmitted in step S200.

In step S102, the CEMS server 2 compares the second charging pattern with the first charging pattern that the CEMS server 2 has transmitted to the power apparatus 17 in step S120. Then, if the first charging pattern and the second charging pattern match, the CEMS server 2 identifies the intended power apparatus and the intended vehicle (see FIG. 4).

In step S103, the CEMS server 2 deletes the first charging pattern used in the comparison process. “Deleting the first charging pattern” refers to “deleting the first charging pattern data stored in the above-mentioned RAM of the CEMS server 2.” In step S120, the CEMS server 2 also generates a first charging pattern that differs from any of the at least one first charging pattern stored in the RAM. The process steps after step S103 are the same as those illustrated in FIG. 5.

The CEMS server 2 according to Embodiment 2 generates a first charging pattern in step S120 (see step S120 of FIG. 7), and deletes the first charging pattern in step S103 after the end of the comparison process. As such, the CEMS server 2 deletes the first charging pattern after pairing the intended power apparatus and the intended vehicle, thereby preventing the number of first charging patterns from increasing excessively. Moreover, Embodiment 2 can obviate the need for the CEMS server 2 to generate the first charging pattern.

Note that, Embodiments 1 and 2 are common in that the first charging pattern of the power apparatus 17 differs from any other first discharging patterns of any other power apparatuses during the time period from when the power apparatus 17 starts charging a vehicle until the end of the comparison process.

### Embodiment 3

In Embodiment 1 and 2 described above, the power apparatus 17 charges the vehicle 18. In Embodiment 3, a vehicle 18 discharges electric power to a power apparatus 17.

In Embodiment 3, each vehicle 18 stores a discharging pattern (a first discharging pattern) unique to the vehicle 18 in a memory 192 (see FIG. 2). The first discharging pattern is a power pattern in which the vehicle 18 discharges an electric power. The first discharging pattern indicates a discharging power value of the vehicle 18 from when the vehicle 18 starts discharging an electric power until a predetermined time period T has passed. The vehicle 18 discharges an electric power in the first discharging pattern to the power apparatus 17.

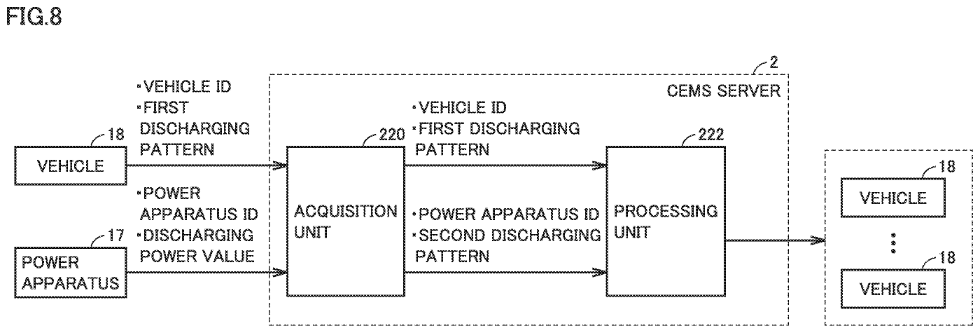

FIG. 8 is a functional block diagram of the CEMS server 2, etc. When the vehicle 18 starts discharging an electric power to the power apparatus 17, the vehicle 18 transmits the first discharging pattern of the vehicle 18 and the vehicle ID of the vehicle 18 to the CEMS server 2. The acquisition unit 220 obtains and outputs the first discharging pattern and the vehicle ID to a processing unit 222.

The power apparatus 17 has a discharge sensor (not shown). Once the vehicle 18 starts discharging an electric power, each time a discharging power value is detected by the discharge sensor, the power apparatus 17 outputs the discharging power value to the CEMS server 2. Once the vehicle 18 starts discharging the electric power, the power apparatus 17 also transmits to the CEMS server 2 the power apparatus ID stored in the memory 192 (see FIG. 2) of the power apparatus 17.

The acquisition unit 220 included in the CEMS server 2 obtains the power apparatus ID and the discharging power value from the power apparatus 17. In turn, the acquisition unit 220 continues to obtain discharging power values from when it starts obtaining discharging power values until a predetermined time period T (e.g., 10 seconds) has passed. The acquisition unit 220 continues to obtain discharging power values over the predetermined time period T, and obtains a discharging pattern (a second discharging pattern) based on the obtained discharging power values. The second discharging pattern is a power pattern in which the power apparatus 17 is supplied with electric power. The second discharging pattern and the power apparatus ID, obtained by the acquisition unit 220, are output to the processing unit 222.

The processing unit 222 compares the first discharging pattern and the second discharging pattern output from the acquisition unit 220, and determines whether the first discharging pattern and the second discharging pattern match. Note that the comparison in the present embodiment is the same as that illustrated in FIG. 4, except for “the second discharging pattern” being replaced with “the first charging pattern” and “the second charging pattern” being replaced with “the first discharging pattern.” In the following, the modified version of FIG. 4 may also be referred to as a “modified FIG. 4.”

If the processing unit 222 determines that the first discharging pattern and the second discharging pattern match, the processing unit 222 identifies that the vehicle 18, having discharged an electric power in the first discharging pattern, has discharged the electric power to the power apparatus 17 supplied with the electric power in the second discharging pattern, which is also referred to as “the vehicle 18 and the power apparatus 17 being paired.” The vehicle 18 is also referred to an “intended power apparatus.” The vehicle is also referred to an “intended vehicle.”

In other words, if the first discharging pattern and the second discharging pattern match, the processing unit 222 identifies the intended power apparatus and the intended vehicle. Upon identifying the intended power apparatus and the intended vehicle, the processing unit 222 causes the intended power apparatus to perform a discharging EM control described below. As described above, according to the power system of Embodiment 3, the vehicle 18 can be authenticated with accuracy even in the event the vehicle 18 discharges electric power to the power apparatus 17.

In the present embodiment, multiple first discharging patterns of multiple vehicles (e.g., the intended vehicle 18A and the intended vehicle 18B in the example of the modified version of FIG. 4 described above), and respectively matching multiple second discharging patterns (the intended power apparatus 17A and the intended power apparatus 17B)) are disclosed. The CEMS server 2 pairs the intended vehicle having discharged an electric power in the first discharging pattern and the intended power apparatus supplied with an electric power in the second discharging pattern. In other words, the CEMS server 2 is able to pair the intended power apparatus 17A with the intended vehicle 18A, and pair the intended power apparatus 17B with the intended vehicle 18B (i.e., multiple paired sets).

[Process Flow]

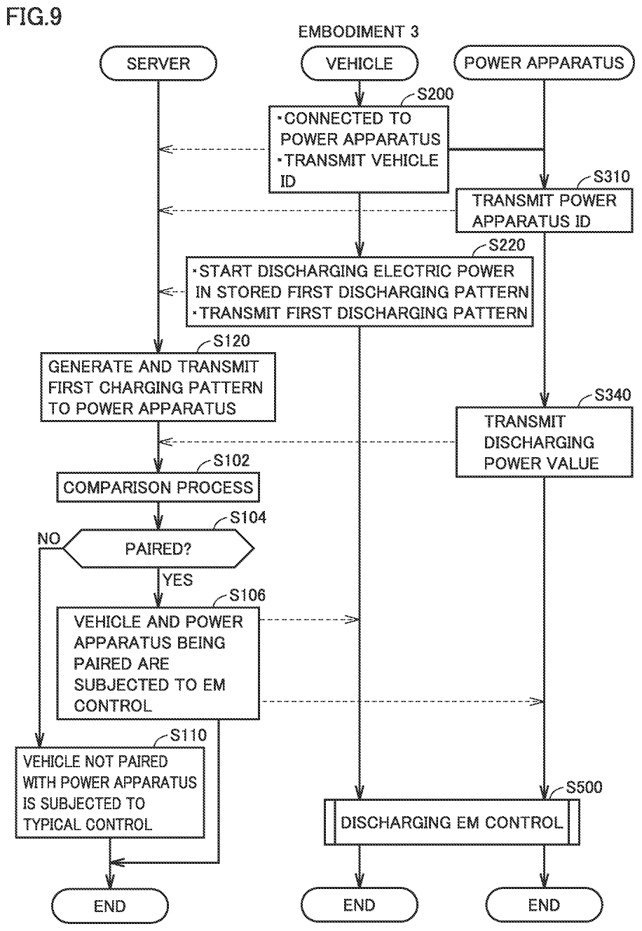

FIG. 9 is a flowchart of a process performed by the CEMS server 2, the power apparatus 17, and the vehicle 18, according to Embodiment 3. The process of step S200 is performed once the vehicle 18 senses that it is connected to the power apparatus 17. In step S310, the power apparatus 17 transmits the power apparatus ID to the CEMS server 2.

In step S220, the vehicle 18 discharges to the power apparatus 17 an electric power in the first discharging pattern stored in the vehicle 18. In step S220, the vehicle 18 also transmits the first discharging pattern of the vehicle 18 to the CEMS server 2.

In step S120, the CEMS server 2 receives the sensed signal transmitted in step S200 and the first discharging pattern transmitted in step S310. In step S120, the CEMS server 2 senses, by this reception, that the vehicle 18 indicated by the vehicle ID transmitted in step S200 has started discharging an electric power to the power apparatus 17 indicated by the power apparatus ID transmitted in step S310.

In step S340, each time the above-mentioned discharge sensor detects a discharging power value, the power apparatus 17 transmits the discharging power value to the CEMS server 2.

Next, in step S102, the CEMS server 2 performs the comparison process. Then, if the first discharging pattern and the second discharging pattern match, the CEMS server 2 identifies the intended power apparatus and the intended vehicle. In step S106, the CEMS server 2 causes the paired intended vehicle and intended power apparatus to perform the discharging EM control. In step S500, the intended vehicle and the intended power apparatus perform the discharging EM control. In contrast, if the first discharging pattern and the second discharging pattern do not match (NO in step S104) the CEMS server 2, in step S110, causes a not-paired vehicle (the non-intended vehicle) to perform a typical control described below. Specifically, the CEMS server 2 transmits a typical-control signal to the non-intended vehicle.

FIG. 10 is a flowchart illustrating one example of the discharging EM control process. Initially, in step S502, the CEMS server 2 obtains a dischargeable amount of electric power of the intended power apparatus from the above-mentioned intended server to which the intended power apparatus belongs. Here, the “dischargeable amount of electric power” is an amount of electric power that can be discharged by the intended vehicle to the intended power apparatus.

The intended server calculates the dischargeable amount of electric power based on a predetermined algorithm, using a total amount of electric power supplied from a MG (a power grid) to an xEMS to which the intended server belongs, and a requested amount of electric power from a load 11A, 12A (see FIG. 1) of the facility (such as the factory 11 or the building 12 of FIG. 1) of the xEMS. The algorithm is defined so that the dischargeable amount of electric power by the intended power apparatus increases with an increase in the requested amount of electric power from the load 11A, 12A. This can increase the dischargeable amount of electric power by the intended power apparatus when the requested amount of electric power by from the load 11A, 12A is great, thereby inhibiting the load 11A, 12A from running into power shortage. The algorithm may also be defined so that the dischargeable amount of electric power by the intended power apparatus decreases with a reduction in the requested amount of electric power from the load 11A, 12A. This allows a less amount of electric power to be reduced in the vehicle 18 for a smaller requested amount of electric power from the load 11A, 12A.

In step S504, the intended vehicle calculates and transmits a dischargeable amount of electric power to the CEMS server 2. Based on the current capacity of the battery 115, the ECU 170 of the intended vehicle (see FIG. 2) calculates the dischargeable amount of electric power. Note that, in an alternative embodiment, the intended vehicle may transmit a dischargeable amount of electric power to the intended power apparatus, and the intended power apparatus, in turn, may transmit the dischargeable amount of electric power to the CEMS server 2.

The intended vehicle transmits the dischargeable amount of electric power to the CEMS server 2. In step S506, the CEMS server 2 calculates the discharged amount of electric power to the intended power apparatus, based on the dischargeable amount of electric power obtained in step S502 and the dischargeable amount of electric power transmitted from the intended vehicle in step S504. For example, in step S506, the CEME server 2 identifies a smaller dischargeable amount of electric power of the dischargeable amount of electric power obtained in step S502 and the dischargeable amount of electric power transmitted from the intended vehicle in step S504, as the discharged amount of electric power from the intended vehicle. The CEMS server 2 then transmits information indicating the identified discharged amount of electric power to the intended vehicle and the intended power apparatus.

The intended power apparatus recognizes the discharged amount of electric power transmitted in step S506. In step S508, the ECU 170 of the intended vehicle shows the discharged amount of electric power transmitted in step S506 on a display 160 (see FIG. 2). This display can allows passengers of the intended vehicle to recognize the discharged amount of electric power.

Furthermore, in step S508, the intended vehicle continues to discharge the discharged amount of electric power transmitted in step S506 to the intended power apparatus. “Continue to discharge” means that the intended vehicle switches from the first discharging pattern of step S220 to a typical pattern and continues to discharge electric power until the completion of discharging of the discharged amount of electric power transmitted in step S506.

As such, in the discharging EM control, even if the discharged amount of electric power determined by the discharging EM control cannot be communicated between the intended vehicle and the intended power apparatus, the CEMS server 2 can transmit the discharged amount of electric power to the intended power apparatus and the intended vehicle. Accordingly, the CEMS server 2 can allow the intended power apparatus and the intended vehicle to recognize the discharged amount of electric power.

As the discharging EM control of FIG. 10 ends, the process returns to FIG. 9 and the process of FIG. 9 ends. Moreover, the CEMS server 2 causes the non-intended vehicle, having been determined as NO in step S104 of FIG. 9, to perform the typical control. The typical control differs from the discharging EM control. In other words, in the typical control, the dischargeable amount of electric power from the non-intended vehicle is independent of a requested amount of electric power from a load. For example, the typical control allows a non-intended vehicle to discharge the calculated dischargeable amount of electric power as is. In this manner, even if a non-intended vehicle discharges an electric power to a non-intended power apparatus while they are not paired, the non-intended vehicle is allowed to discharge the electric power properly.

### Embodiment 4

In Embodiment 3 described above, the vehicle 18 stores the first discharging pattern unique to the vehicle 18. In Embodiment 4, a CEMS server 2 generates a first discharging pattern for a vehicle 18 and transmits the first discharging pattern to the vehicle 18. The vehicle 18, in turn, discharges an electric power in the first discharging pattern to the power apparatus 17.

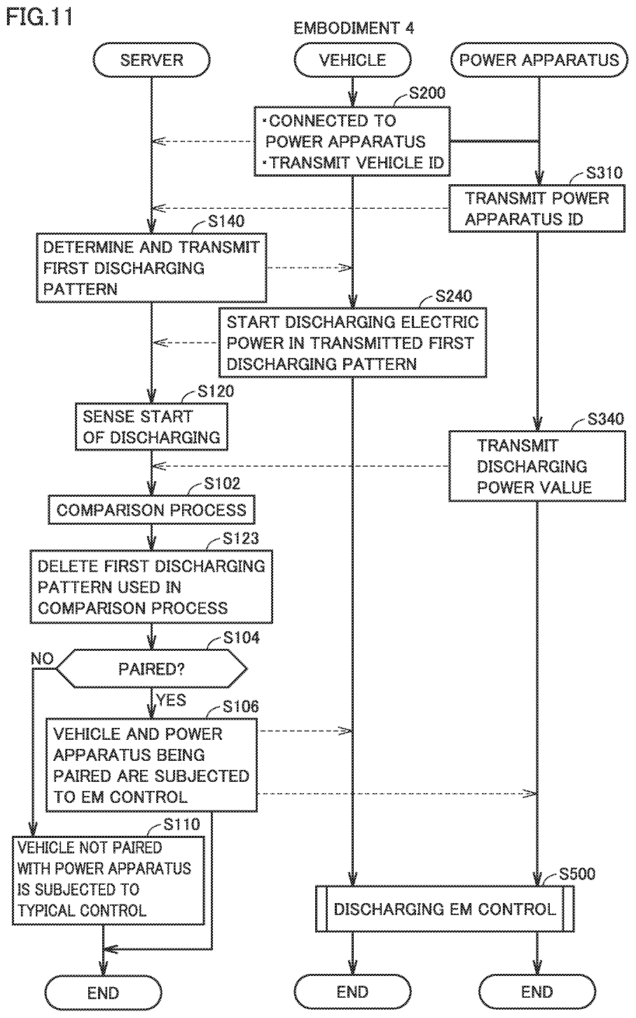

FIG. 11 is a flowchart of a process performed by the CEMS server 2, the power apparatus 17, and the vehicle 18, according to Embodiment 4.

Upon receiving a vehicle ID transmitted in step S200, the CEMS server 2, in step S140, generates a first discharging pattern. Here, the first discharging pattern differs from a first discharging pattern being used. The “first discharging pattern being used” refers to a first discharging pattern that is present since being generated in step S140 until being deleted in step S123 described below. Accordingly, during a time period from when the power apparatus 17 starts discharging an electric power until the end of the comparison process of step S102, the first discharging pattern generated in step S120 differs from any other first discharging patterns for any other power apparatuses.

In step S140, the CEMS server 2 stores the generated first discharging pattern into a RAM included in the CEMS server 2, and transmits the first discharging pattern to the vehicle 18 which is a source of the vehicle ID.

Upon receiving the first discharging pattern from the CEMS server 2, the vehicle 18, in step S240, starts discharging an electric power in the first discharging pattern. The vehicle 18 transmits to the CEMS server 2 a start signal indicating that the discharging has started. In step S120, the CEMS server 2 senses, by receiving the start signal, that the vehicle 18 indicated by the vehicle ID transmitted in step S200 has started discharging an electric power to the power apparatus 17 indicated by the power apparatus ID transmitted in step S310.

In step S340, each time the power apparatus 17 detects a discharging power value, the power apparatus 17 transmits the discharging power value to the CEMS server 2.

In step S102, the CEMS server 2 compares the second discharging pattern with the first discharging pattern that the CEMS server 2 has transmitted to the vehicle 18 in step S140. Then, if the first discharging pattern and the second discharging pattern match, the CEMS server 2 identifies the intended power apparatus and the intended vehicle.

In step S123, the CEMS server 2 deletes the first discharging pattern used in the comparison process. “Deleting the first discharging pattern” refers to “deleting the first discharging pattern data stored in the above-mentioned RAM of the CEMS server 2.” In step S120, the CEMS server 2 also generates a first discharging pattern that differs from any of the at least one first discharging pattern stored in the RAM. The process steps after step S123 are the same as those illustrated in FIG. 9.

The CEMS server 2 according to Embodiment 4 generates a first discharging pattern in step S120 (see step S120 of FIG. 11), and deletes the first discharging pattern in step S123 after the end of the comparison process. As such, the CEMS server 2 deletes the first discharging pattern after pairing the intended power apparatus and the intended vehicle, thereby preventing the number of first discharging patterns from increasing excessively. Moreover, Embodiment 3 can obviate the need for the CEMS server 2 to generate the first discharging pattern.

Note that Embodiments 1 and 2 are common in that the first discharging pattern of the vehicle 18 differs from any other first discharging patterns of any other vehicles during the time period from when the vehicle 18 starts discharging an electric power until the end of the comparison process.

### Other Embodiments

(1) In the above embodiments, the predetermined time periods defined by the charging pattern and the discharging pattern are the predetermined time period T (see FIG. 4, etc.). However, the predetermined time period may be a predetermined amount of electric power. For example, a predetermined amount of electric power for the charging pattern may be a total amount of charged electric power. A predetermined amount of electric power for the discharging pattern may be a total amount of discharged electric power.
(2) Embodiments 1 and 2 have been described, with reference to the power apparatus 17 charging the vehicle 18, and Embodiments 3 and 4 have been described with reference to the vehicle 18 discharging an electric power to the power apparatus 17. However, the power apparatus 17 may be capable of both charging the vehicle 18 and allowing the vehicle 18 to discharge an electric power discharged from the power apparatus 17.
(3) Moreover, the processing performed by “the server” according to the present disclosure may be performed only by the CEMS server 2, performed only by a server included in the xEMS, or performed by the CEMS server 2 and the server included in the xEMS.
(4) Embodiment 1 has been described, with reference to each power apparatus 17 storing a unique first charging pattern and transmitting the first charging pattern to the CEMS server 2. However, the CEMS server 2 may store the first charging patterns of all the power apparatuses 17. If such a configuration is adopted, the process can be eliminated that the power apparatus 17 transmits the first charging pattern to the CEMS server 2. Embodiment 3 has been described, with reference to each vehicle 18 storing a unique first discharging pattern and transmitting the first discharging pattern to the CEMS server 2. However, the CEMS server 2 may store the first discharging patterns of all the vehicles 18. If such a configuration is adopted, the process can be eliminated that the vehicle 18 transmits the first discharging pattern to the CEMS server 2.
(5) The above embodiments discloses that one power apparatus 17 is provided with one connector 172. However, one power apparatus 17 may be provided with multiple connectors 172. If such a configuration is adopted, the connectors 172 function as multiple power apparatuses 17.
(6) Embodiments 1 and 2 have been described, with reference to the vehicle 18 transmitting, each time it detects a charging power value, the charging power value to the CEMS server 2, and the CEMS server 2 obtaining the second charging pattern based on the charging power value. However, the vehicle 18 itself may generate the second charging pattern based on the charging power value, and transmit the second charging pattern to the CEMS server 2. Embodiments 3 and 4 have been described, with reference to the power apparatus 17 transmitting, each time it detects a discharging power value, the discharging power value to the CEMS server 2, and the CEMS server 2 obtaining the second discharging pattern based on the discharging power value. However, the power apparatus 17 itself may generate the second discharging pattern based on the discharging power value, and transmits the second discharging pattern to the CEMS server 2.

While the embodiments of the present disclosure have been described, the embodiments presently disclosed should be considered illustrative in all aspects and do not limit the present disclosure. The scope of the present disclosure is indicated by the appended claims, and all changes which come within the meaning and range of equivalency of the appended claims are intended to be included within the scope of the present disclosure.

What is claimed is:

1. A power system, comprising:
a server;
at least one power apparatus; and
at least one vehicle, wherein
the power apparatus charges the vehicle in a first charging pattern, the first charging pattern being a power pattern in which the power apparatus discharges an electric power and indicating charging power values from when the power apparatus starts charging the vehicle until a predetermined time period has passed, and
if the first charging pattern and a second charging pattern match, the second charging pattern being a power pattern in which the vehicle is charged and indicating charging power values from a start of charge of the vehicle by the power apparatus until the predetermined time period has passed, the server pairs an intended power apparatus having performed charging in the first charging pattern and an intended vehicle charged in the second charging pattern.

2. The power system according to claim 1, wherein
the power apparatus transmits a first charging pattern unique to the power apparatus to the server, and
if the first charging pattern transmitted from the power apparatus and the second charging pattern transmitted from the vehicle match, the server pairs the power apparatus as the intended power apparatus and the vehicle as the intended vehicle.

3. The power system according to claim 1, wherein
when the server starts charging by the power apparatus, the server generates and transmits to the power apparatus a first charging pattern that differs from a first charging pattern being used,
the power apparatus charges the vehicle in the first charging pattern transmitted by the server,
if the second charging pattern and the first charging pattern that the server has transmitted to the power apparatus match, the server pairs the intended power apparatus and the intended vehicle, and
the server deletes the generated first charging pattern after pairing the intended power apparatus and the intended vehicle.

4. The power system according to claim 1, further comprising:
a load which consumes an electric power, wherein
the server controls the intended power apparatus so that an amount of electric power charged by the intended power apparatus decreases with an increase in a requested amount of electric power from the load.

5. The power system according to claim 4, wherein
the server identifies a non-intended power apparatus which charges a vehicle in the first charging pattern that does not match the second charging pattern, and
the server controls the non-intended power apparatus so that a chargeable amount of electric power by the non-intended power apparatus is independent of the requested amount of electric power.

6. The power system according to claim 4, wherein
the server obtains a chargeable amount of electric power by the intended power apparatus,
the intended vehicle or the intended power apparatus transmits the chargeable amount of electric power of the intended vehicle to the server,
the server determines the amount of electric power charged by the intended power apparatus, based on the chargeable amount of electric power by the intended power apparatus and a chargeable amount of electric power of the intended vehicle, and transmits, to the intended power apparatus and the intended vehicle, information indicating the amount of electric power charged by the intended power apparatus.

7. The power system according to claim 1, wherein
the at least one power apparatus includes a plurality of power apparatuses,
the at least one vehicle includes a plurality of vehicles,
the plurality of power apparatuses charge vehicles in a plurality of first charging patterns that are different from each other,
the plurality of vehicles are charged in a plurality of second charging patterns that are different from each other,
in the plurality of first charging patterns and the plurality of second charging patterns respectively matching the plurality of first charging patterns, the server pairs the intended power apparatus having charged a vehicles in a first charging pattern and the intended vehicle charged in a second charging pattern.

8. A power system, comprising:
a server;
at least one power apparatus; and
at least one vehicle, wherein
the vehicle discharges an electric power in a first discharging pattern to the power apparatus, the first discharging pattern being a power pattern in which the vehicle discharges an electric power and indicating discharging power values from when the vehicle starts discharging the electric power until a predetermined time period has passed, and
if the first discharging pattern and a second discharging pattern match, the second discharging pattern being a power pattern in which the power apparatus is supplied with an electric power and indicating discharging power values from when the vehicle starts discharging the electric power until the predetermined time period has passed, the server pairs an intended vehicle having discharged an electric power in the first discharging pattern and an intended power apparatus having been discharged an electric power to in the second discharging pattern.

9. The power system according to claim 8, wherein
a vehicle transmits a first discharging pattern unique to the vehicle to the server, and
if a first discharging transmitted from a vehicle and a second discharging transmitted from a power apparatus match, the server pairs the power apparatus as the intended power apparatus and the vehicle as the intended vehicle.

10. The power system according to claim 8, wherein
when the vehicle starts discharging an electric power, the server generates and transmits to the vehicle a first discharging pattern that differs from a first discharging pattern being used,
the vehicle discharges an electric power in the first discharging pattern transmitted from the server, and
if the second discharging pattern and the first discharging pattern that the server has transmitted to the vehicle match, the server pairs the intended power apparatus and the intended vehicle, and
the server deletes the generated first discharging pattern after pairing the intended power apparatus and the intended vehicle.

11. The power system according to claim 8, further comprising
a load which consumes an electric power, and
the server controls the intended vehicle so that a discharged amount of electric power by the intended vehicle increases with an increase of a requested amount of electric power from the load.

12. The power system according to claim 11, wherein
the server identifies a non-intended vehicle which discharges an electric power in a first discharging pattern that does not match a second discharging pattern, and
the server controls the non-intended vehicle so that a dischargeable amount of electric power by the non-intended vehicle is independent of the requested amount of electric power.

13. The power system according to claim 11, wherein
the server obtains a dischargeable amount of electric power to the intended power apparatus,
the intended vehicle or the intended power apparatus transmits to the server a dischargeable amount of electric power by the intended vehicle, and
the server determines the discharged amount of electric power, based on the dischargeable amount of electric power to the intended power apparatus and the dischargeable amount of electric power by the intended vehicle, and transmits, to the intended power apparatus and the intended vehicle, information indicating the discharged amount of electric power.

14. The power system according to claim 8, wherein
the at least one power apparatus includes a plurality of power apparatuses,
the at least one vehicle includes a plurality of vehicles,
the plurality of vehicles discharge electric powers to power apparatuses in a plurality of first discharging patterns that are different from each other,
the plurality of power apparatuses are supplied with electric powers in a plurality of second discharging pattern that are different from each other, and
in the plurality of first charging patterns and the plurality of second discharging patterns respectively matching the plurality of first discharging patterns, the server pairs the intended vehicle discharged an electric power in a first discharging pattern and the intended power apparatus supplied with an electric power in a second discharging pattern.
